(19) United States
(12) Patent Application Publication
(10) Pub. No.: US 2012/0103356 A1
(43) Pub. Date: May 3, 2012

(54) EATING UTENSIL INCORPORATING ORAL HYGIENIC FACILITY

(76) Inventor: Jackson L. Crisp, Sundance, WY (US)

(21) Appl. No.: 13/348,604

(22) Filed: Jan. 11, 2012

Related U.S. Application Data
(63) Continuation-in-part of application No. PCT/US09/66977, filed on Dec. 7, 2009.
Application No. PCT/US09/66977 is a continuation-in-part of application No. 12/693,913, filed on Jan. 26, 2010.
Application No. 12/693,913 is a continuation-in-part of application No. 12/687,171, filed on Jan. 14, 2010.
Application No. 12/687,171 is a continuation-in-part of application No. 12/592,653, filed on Dec. 1, 2009.
Application No. 12/687,171 is a continuation-in-part of application No. 12/592,653, filed on Dec. 1, 2009.
Application No. 12/687,171 is a continuation-in-part of application No. 12/231,274, filed on Sep. 2, 2008, now abandoned.
(60) Provisional application No. 61/133,106, filed on Jun. 25, 2008.

(51) Int. Cl. A47G 21/06; A61C 15/00; A46B 15/00; A47G 21/02

(52) U.S. Cl. 132/200; 30/123; 30/150; 30/147; 30/148; 30/149

(57) ABSTRACT

An eating utensil such as a disposable plastic fork, spoon, knife, or combination thereof, is combined with at least one oral hygienic device such as a toothpick, interdental pick-brush, brush, tongue cleaner and/or a dental flosser for personal use after eating in a location where oral hygienic facilities may not be otherwise available. In some embodiments the oral hygienic device may be permanently attached to the eating utensil, which can serve as a handle for using the oral hygienic device. In other embodiments the oral hygienic device may be displaced in a snap-off or bend-away manner at score lines to expose the oral hygienic device for use, either still attached to the utensil or removed for separate use, optionally configured with a thumb-finger grip tab.

### RELATED APPLICATIONS

The present application is a continuation-in-part of U.S. application Ser. No. 12/693,913, filed Jan. 26, 2010, entitled Eating Utensil Incorporating Dental Flosser, which is listed as a divisional of U.S. application Ser. No. 12/231,274, filed Sep. 2, 2008, entitled Eating Utensil Incorporating Oral Hygienic Facilities, which claims priority to U.S. Provisional Application No. 61/133,106, filed Jun. 25, 2008, entitled Toothpick Incorporated Fork, all of which are incorporated herein by reference.

The present application is a continuation-in-part of U.S. application Ser. No. 12/687,171, filed Jan. 14, 2010, entitled Oral Hygienic Facility, which is a continuation-in-part of U.S. application Ser. No. 12/231,274, filed Sep. 2, 2008, entitled Eating Utensil Incorporating Oral Hygienic Facilities, which claims priority to U.S. Provisional Application No. 61/133,106, filed Jun. 25, 2008, entitled Toothpick Incorporated Fork, and U.S. application Ser. No. 12/687,171 is also a continuation-in-part of U.S. application Ser. No. 12/592,653, filed Dec. 1, 2009, entitled Eating Utensil Incorporating Oral Cleaning Facility, which is listed as a divisional of U.S. application Ser. No. 12/231,274, filed Sep. 2, 2008, entitled Eating Utensil Incorporating Oral Hygienic Facilities, which claims priority to U.S. Provisional Application No. 61/133,106, filed Jun. 25, 2008, entitled Toothpick Incorporated Fork, all of which are incorporated herein by reference.

The present application is a continuation-in-part of U.S. application Ser. No. 12/592,653, filed Dec. 1, 2009, entitled Eating Utensil Incorporating Oral Cleaning Facility, which is listed as a divisional of U.S. application Ser. No. 12/231,274, filed Sep. 2, 2008, entitled Eating Utensil Incorporating Oral Hygienic Facilities, which claims priority to U.S. Provisional Application No. 61/133,106, filed Jun. 25, 2008, entitled Toothpick Incorporated Fork, all of which are incorporated herein by reference.

The present application is a continuation-in-part of International Application No. PCT/US09/66977, filed Dec. 7, 2009, entitled Eating Utensil Incorporating Oral Hygienic Facility, which is incorporated herein by reference.

The present application also incorporates herein by reference the following published patent applications: International PCT Application Publication No. WO 2011/071481, published Jun. 16, 2011; U.S. Patent Application Publication No. 2011-0113634 A1, published May 19, 2011; U.S. Patent Application Publication No. 2011-0132392 A1, published Jun. 9, 2011; U.S. Patent Application Publication No. 2010-0107419 A1, published May 6, 2010; and U.S. Patent Application Publication No. 2010-0107417 A1, published May 6, 2010.

### TECHNICAL FIELD

The present invention is in the fields of eating utensils and oral hygienic devices, more particularly the invention relates to an eating utensil that incorporates an oral hygienic device from a group that includes flossers, toothpicks, tongue-cleaners and oral brushes. Optimally one or more additional oral cleaning devices may be incorporated.

### BACKGROUND

Eating activity often involves the use of disposable eating utensils, such as plastic forks, spoons and/or knives, typically at away-from-home locations where facilities for oral hygienic cleaning after eating are unavailable. Such eating activity may include planned picnics, picnics-on-the-go, fast food, takeout, lunch boxes, bagged lunches at work, eating-on-the-go, delivered specialties, catered food engagements, entertainment events, birthdays, cocktail-parties, weddings and other parties.

U.S. design Pat. D254,239 to Julius for a COMBINED FORK AND SEPARATABLE TOOTHPICK shows the ornamental design for the subject matter.

U.S. design Pat. D463,231 to Sanders for EATING UTENSIL WITH TOOTHPICK INCORPORATED THEREIN shows a fork, spoon and knife each with a toothpick located on the front side near the handle end; presumably the toothpick is removably attached in each case.

U.S. Pat. No. 2,877,547 for COMBINATION TOOTHPICK AND STIRRING OR EATING IMPLEMENT to Feaster discloses wooden spoons, forks and stifling sticks configured with knockout-removable toothpicks.

U.S. Pat. No. 2,072,777 to Takahashi for CUTLERY shows a spoon and a fork each with a pair of toothpicks removably attached on the rear side.

U.S. Pat. No. 3,664,020 to Hammond et al for COMBINATION SPOON AND TOOTHPICK shows and discloses a toothpick and spoon combination including a handle portion with a separable toothpick member for use after eating. The combination utilizes support members from which the toothpick may be broken away.

### SUMMARY

Disposable plastic utensils incorporating an oral hygienic device such as a straight or curved toothpick, oral brushes, tongue cleaners and dental floss may be provided along with one or more optional additional devices for maintaining good oral health at eating events where oral hygiene devices may not be otherwise available.

Snap-off embodiments may be provided wherein an oral hygienic device, initially formed attached in a protective manner in an opening in the utensil handle, can be user-displaced in a snap-off manner and removed for separate usage, and further, to provide bend-away embodiments wherein a device, permanently attached in protective manner within the utensil handle, can be user-displaced in a bend-away manner that exposes the still-attached device, ready for use.

A plastic eating utensil may be combined with an oral hygienic device that can be molded integrally with the utensil handle, initially attached to the handle and typically protected by adjacent or surrounding handle material. To deploy a protected device, one or more score lines configured in the handle can enable user displacement of the device and/or selected area of handle material in a manner to expose the device ready for usage. User-displacement can be implemented in different embodiments as either non-separation bend-away or snap-off separation, depending on design choice of plastic material for resilience, and of score line configuration, particularly depth. A eating utensil incorporating oral hygienic facility is now made for use after eating in a location where oral hygiene items may not be otherwise available.

This Summary is provided to introduce a selection of concepts in a simplified form. The concepts are further described below in the Detailed Description. This Summary is not intended to identify key features or essential features of the claimed subject matter, nor is it intended to be used to limit the scope of the claimed subject matter. Similarly, the invention is not limited to implementations that address the particular techniques, tools, environments, disadvantages, or advantages discussed in the Background, the Detailed Description, or the attached drawings.

### BRIEF DESCRIPTION OF THE DRAWINGS

The above and further objects, features and advantages will be more fully understood from the following description taken with the accompanying drawings.

FIG. 1 shows a front view of a fork configured with an attached flosser holding floss at an angled orientation.

FIG. 2 depicts a knife configured to incorporate a flosser holding floss oriented longitudinally.

FIG. 3 depicts a spoon combined with a flosser and a snap-off key-shaped toothpick that includes a thumb-finger grip located within the flosser opening.

FIG. 4 depicts a spork (spoon/fork) with a snap-off handle end portion that includes an attached flosser, toothpick and thumb-finger grip. NOTE: It is to be understood that the invention can be practiced with each handle/device configuration disclosed herein, in conjunction with in any one of four alternative utensil configurations shown in FIGS. 1-4, i.e. fork 10A, knife 12A, spoon 14A or spork 16A. Therefore in the following FIGS. 5-22, 40-44 the handle is shown cut-away at the lower end.

FIG. 5 depicts a cut-away front view of a utensil handle with an attached tapered toothpick protected by a snap-off guard portion that includes a flosser.

FIG. 6 depicts a cut-away front view of a utensil handle with an attached curved toothpick protected by a snap-off guard portion that includes a flosser.

FIG. 7 depicts a cut-away front view of a utensil handle with an attached interdental pick protected by a snap-off guard portion that includes a flosser.

FIG. 8 depicts a cut-away front view of a utensil handle with an attached interdental brush protected by a snap-off guard portion that includes a flosser.

FIG. 9 depicts a cut-away front view of a utensil handle with a flosser and a snap-off guarded straight toothpick.

FIG. 10 depicts a cut-away front view of a utensil handle with flosser that can be angled at a bend line.

FIG. 11 depicts a cut-away side view of the handle of FIG. 10 showing the angled flosser.

FIG. 12 depicts a cut-away front view of a utensil handle configured with an attached tapered toothpick and a foldably-attached flosser.

FIG. 13 depicts a cut-away side view of the handle of FIG. 12 showing the combined flosser and toothpick in initial co-linear alignment.

FIG. 14 depicts handle of FIG. 12 with the flosser folded back, exposing the toothpick.

FIG. 15 is a side view of the subject matter of FIG. 14 showing the flosser folded back, exposing toothpick.

FIG. 16 is cut-away front view of a utensil handle including a flosser and a tongue cleaner.

FIG. 17 is a cut-away side view of a utensil handle including a flosser, a tongue cleaner and a bristle brush.

FIG. 18 is a cut-away front view of a utensil handle including a flosser and a bristle brush.

FIG. 19 is a cut-away front view of a utensil handle including a flosser and a combination interdental pick and an interdental brush attached to a grip tab.

FIG. 20 is a cut-away front view of a utensil handle with a dental flosser removably attached to a side edge of the handle.

FIG. 21 is a cut-away front view of a utensil handle with a removable side-attached a flosser and a removable key-shaped toothpick with its tab located in the flosser opening.

FIG. 22 is a cut-away front view of a utensil handle with a removably-attached side panel containing a flosser, a key-shaped curved toothpick and a key-shaped interdental brush removably attached to the side panel.

FIG. 23 shows a fork with a curved toothpick attached at the end region alongside an adjacent guard tab that is attached to the handle in a manner to be displaceable at a score line.

FIG. 24 shows a user's hands in process of displacing the toothpick of FIG. 1 for exposure and use.

FIG. 25 shows a fork with a curved toothpick extending from an end region that is score-line-attached to the handle.

FIG. 26 shows a fork with an edge-located tapered toothpick attached to an end tab that is score-line-attached to the handle.

FIG. 27 shows a fork with an attached centered tapered toothpick guarded by an end tab that is displaceably attached to the handle by a pair of score lines.

FIG. 28 shows a fork with a centered curved toothpick attached to an end tab that is displaceably attached to the handle by a pair of score lines.

FIG. 29 shows a fork with an end-located curved toothpick attached by a score line.

FIG. 30 shows a fork with an edge-located score-line-attached straight toothpick.

FIG. 31 shows a fork with a centered score-line-attached straight toothpick.

FIG. 32 shows a fork with an attached curved toothpick extending longitudinally from the end of the handle, ready-to-use.

FIG. 33 depicts a fork with an attached curved toothpick extending laterally from the end of the handle, ready-to-use.

FIG. 34 depicts a fork configured with an attached ready-to-use flosser and a guarded centrally-located removably-attached straight toothpick.

FIG. 35 depicts a fork configured with a user-displaceable combination flosser and edge-located tapered toothpick.

FIG. 36 depicts a fork configured with a user-displaceable combination flosser and centrally-located tapered toothpick.

FIG. 37 depicts a cutlery knife combined with a removable grip-tab toothpick.

FIG. 38 depicts a spoon combined with a displaceable interdental pick configured with a grip-tab that initially constitutes the end region of the handle.

FIG. 39 depicts a spork (spoon/fork) combined with a displaceable grip-tab oral brush.

FIG. 40 is a front cut-away view of a utensil handle showing a tongue cleaner integrally formed in the end region of the handle.

FIG. 41 is a cut-away side view of the utensil handle of FIG. 40 showing the tongue cleaner of FIG. 40 on one side and a bristle brush located on the opposite side.

FIG. 42 is a rear view of the utensil handle of FIG. 40 showing the bristle brush of FIG. 41 in the end region.

FIG. 43 is a cut-away front view of a utensil handle configured with a straight grip-tab toothpick and a tongue cleaner in the end region.

FIG. 44 is a rear view of the utensil handle of FIG. 43 equipped with straight grip-tab toothpick and an oral brush in the end region.

FIG. 45 is a front cut-away view of a utensil handle showing an, optional snap-off, interdental brush integrally formed in the end region of the handle.

FIGS. 46 and 47 show cutaway side profile views of two possible score-line types, FIG. 46 related score-line arc shaped with no stress concentration points and FIG. 47 u-shaped with two potential stress concentration points.

### DETAILED DESCRIPTION

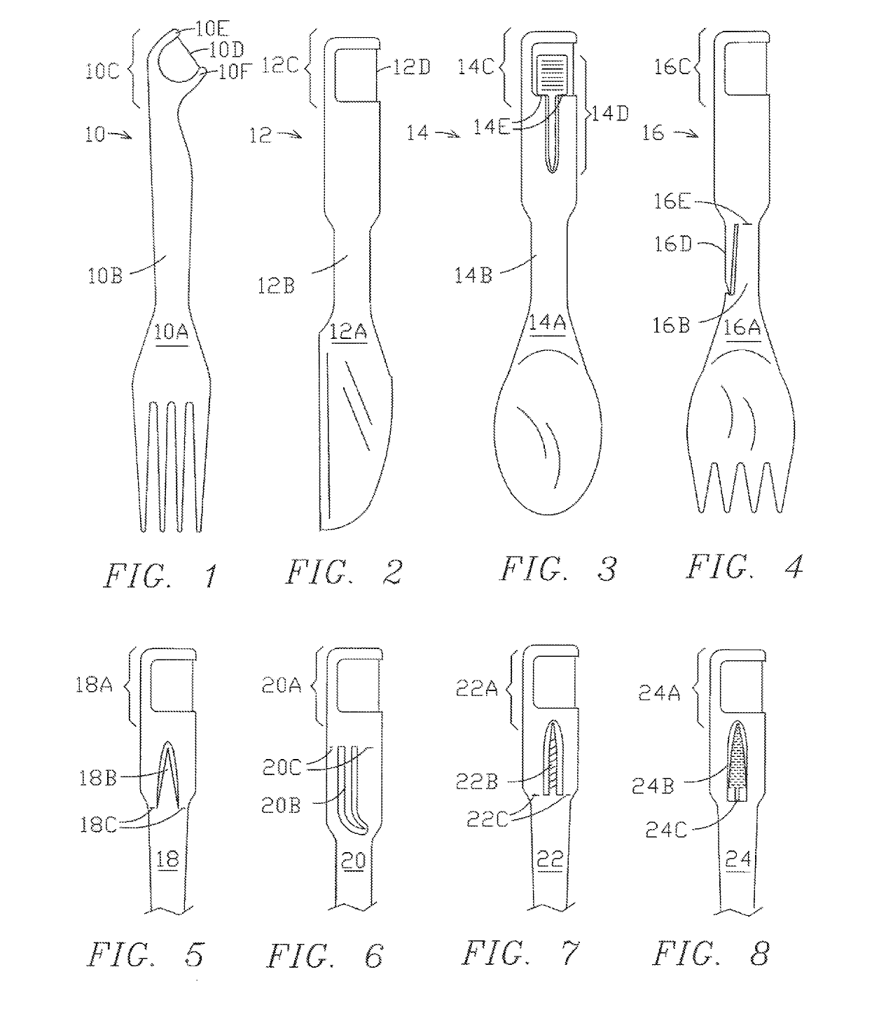

FIG. 1 depicts an embodiment 10 of the invention wherein the utensil portion is a fork 10A having a handle portion 10B configured with an attached flosser 10C suspending a length of floss 10D across a flosser gap formed by ends 10E and 1OF holding the floss 10D oriented at a selected angle as shown. The floss 10D can be molded into the plastic of flosser gap ends 10E and 10F at manufacture.

FIG. 2 shows an embodiment 12 wherein the utensil portion is a knife 12A having handle portion 12B containing a flosser 12C holding floss 12D in a longitudinal orientation as shown.

FIG. 3 depicts an embodiment 14 wherein the utensil portion is a spoon 14A having handle portion 14B with an end region containing a flosser 14C and a hygienic device, in this embodiment a toothpick 14E, configured with an enlarged base end forming a thumb-finger grip tab that is located within the opening of flosser 14C as shown. The toothpick portion extends down into a slot configured in handle portion 14B. The key-shaped toothpick 14E is removably held in place within the flosser opening by a pair of snap-off score lines 14F at the bottom side of the tab. Alternatively such removable fastening could be located anywhere along any edge of the tab.

FIG. 4 depicts an embodiment 16 wherein the utensil portion is a spork 16A (combination spoon/fork) having a handle portion 16B initially including an end region containing a flosser 16C. Handle 16B is also configured with a tapered toothpick 16D at one edge, and a snap-off score line 16E that enables snap-off removal of flosser 16C and toothpick 16D along with a finger grip region. Alternatively, the snap-off score line 16E could be relocated to extend across the base end of the toothpick, enabling snap-off of the toothpick alone.

FIG. 5 depicts a cut-away front view of a utensil handle 18 configured with a flosser 18A in the end region and an attached tapered toothpick 18B which, when flosser 18A is removed by snapping off at score lines 18C, exposes the toothpick 18B ready to use, attached to the handle 18.

FIG. 6 depicts a cut-away front view of a utensil handle 20 configured with a flosser 20A which, when snapped off at score lines 20C, exposes curved toothpick 20B.

FIG. 7 depicts a fork cut-away front view of a utensil handle 22 configured with a flosser 22A which, when snapped off at score lines 22C, exposes an interdental pick 22B that is made sufficiently thin and abrasive to enable cleaning the interface region between the edges of adjacent teeth.

FIG. 8 depicts a cut-away front view of a utensil handle 24 configured with a flosser 24A which, when snapped off at score lines 24C, exposes an interdental brush 24B that is made sufficiently thin and abrasive to enable cleaning the interface region between the edges of adjacent teeth.

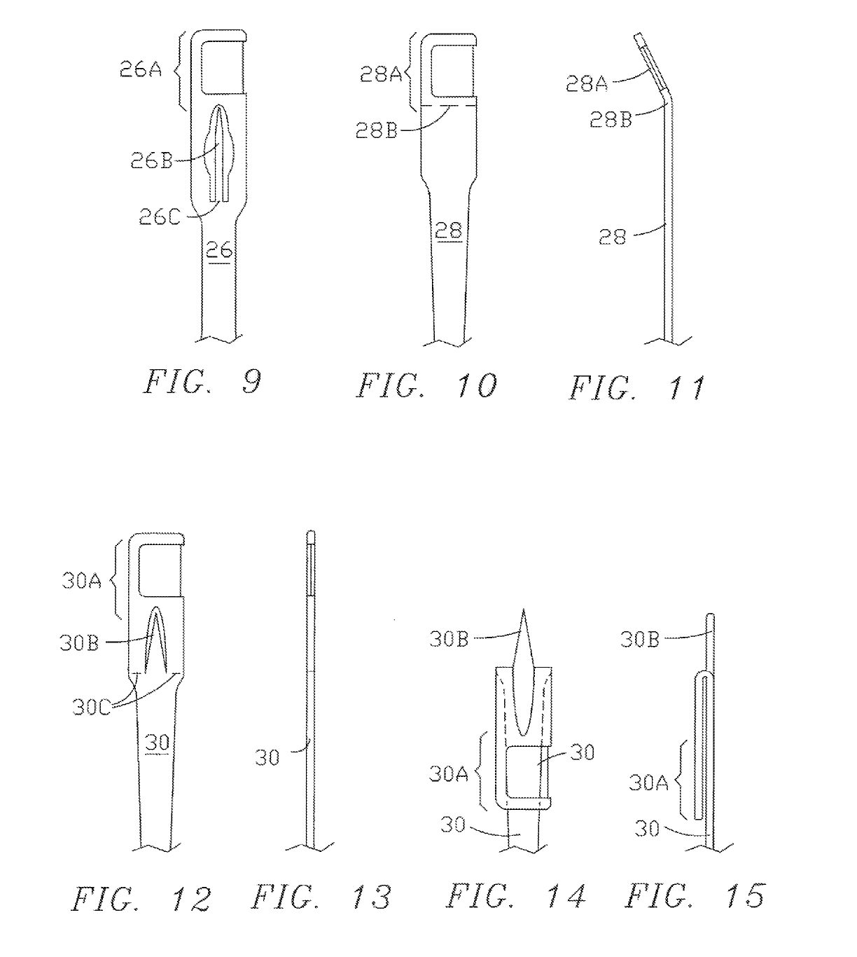

FIG. 9 depicts a cut-away front view of a utensil handle 26 configured with a flosser 26A and a straight toothpick 26B that snaps off at score line 26C.

FIG. 10 depicts a cut-away front view of a utensil handle 28 configured with flosser 28A, oriented at a designated angle relative to handle 28 as enabled by a lateral bend line 28B configured in handle 28.

FIG. 11 depicts a cut-away side view of a utensil handle 28 of FIG. 10 configured with flosser 28A, oriented at the designated angle relative to handle 28 as enabled by lateral bend line 28B.

FIG. 12 depicts a cut-away front view of a utensil handle 30 in combination with an attached flosser 30A and a tapered toothpick 30B which is formed integrally with handle 30. Living hinge bend lines 30C are provided with special handle material to allow bending as much as 180 degrees.

FIG. 13 depicts a cut-away side view of utensil handle 30 of FIG. 12 showing the end region with flosser 30A initially in collinear alignment with handle 30.

FIG. 14 depicts a cut-away front view of utensil handle 30 of FIGS. 12 and 13 showing the end region with flosser 30A having been bent forward 180 degrees at bend lines 30C (FIG. 12) exposing tapered toothpick 30B ready for use as shown.

FIG. 15 depicts cut-away side view of utensil handle 30 of FIG. 14 showing the end region with flosser 30A, as in FIG. 14, having been bent forward 180 degrees at bend lines 30C (FIG. 12) exposing tapered toothpick 30B ready for use as shown.

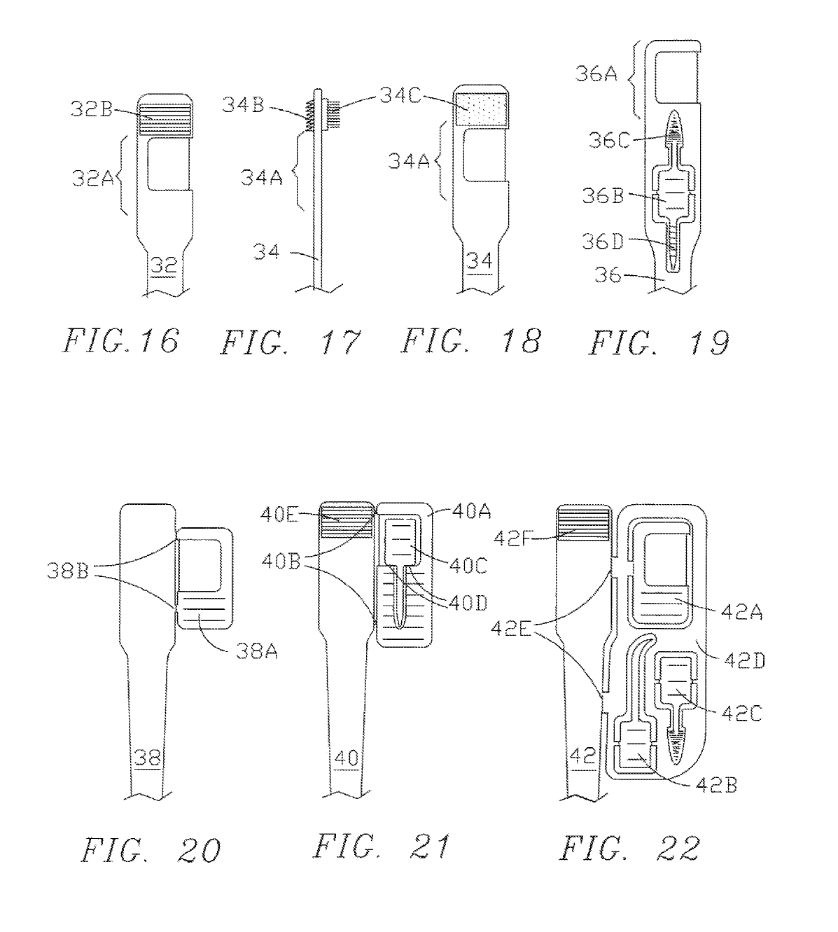

FIG. 16 is cut-away front view of a utensil handle 32 including a flosser 32A and a tongue cleaner 32B arranged as shown. Tongue cleaner 32B can be implemented as a row of ridges that can be molded integrally with handle portion 32. Alternatively, the tongue cleaner can be implemented as at least one scraping edge, intended to scrape the tongue to remove debris while not causing injury to tongue. Furthermore, the region of handle portion 32 that contains the tongue cleaner could be made with permanent bends or flexible so as to make accessing the tongue easier; the tongue cleaner could be configured with at least one opening that allows debris from the scraping action to pass thru, preferably to a designated collection area.

FIG. 17 is a cut-away side view of a utensil handle 34 including a flosser 34A, a tongue cleaner 34B and a bristle brush 34C. The side view of tongue cleaner 34B shows a saw tooth profile shape of the ridges, also applicable to tongue cleaner 32B (FIG. 16), with the ridge-tips being formed with a designated sharpness, appropriate to tongue cleaning. Brush 34 is typically fabricated as a separate item, with bristles of appropriate length and stiffness, and affixed to handle 32.

FIG. 18 is a cut-away front view of the utensil handle 34, flosser 34A and brush 34C of FIG. 17. Optionally brush 34C could be implemented as any type of brush or oral brush, i.e. any brush that can be used orally, including but is not limited to bristle-type oral brushes, interdental-type oral brushes, pad/fabricate-type of brushes and combinations thereof. The oral brush can be directly molded into the eating utensil handle and/or applied to an eating utensil handle in a secondary assembly application. The portion of the utensil handle that contains the oral brush could be made with permanent bends or made flexible so as to make accessing teeth/tongue easier; and bristle-type oral brushes could vary in such areas as, but not limited to, count, arrangement, stiffness, color, width, length, material, attachment method to base and combinations thereof.

FIG. 19 is a cut-away front view of a utensil handle 36 including a flosser 36A and a combination of two interdental devices attached to a finger grip tab 36B: an interdental brush 36C and an interdental pick 36D, both made sufficiently thin to perform cleaning in the interface between adjacent teeth.

FIG. 20 is a cut-away front view of a utensil handle 38 with a dental flosser 38 removably attached to a side edge of handle 38. Score lines 38B at the attachment locations enable snap-off removal flosser 38A for separate usage. The extension region shown in the lower portion of flosser 38A provides a thumb-finger grip tab.

FIG. 21 is a cut-away front view of a handle 40 with a side edge removably attached to a flosser 40A via a pair of snap-off fastenings 40B. A toothpick 40C is configured with an enlarged base end forming a thumb-finger grip tab that is located within the flosser opening; the toothpick portion extends down into a slot configured in a widened lower arm of flosser 40A. The key-shaped toothpick 40C is removably held in place within by a pair of snap-off score lines 40D at the bottom side of the tab. Alternatively such removable fastening could be located anywhere along any edge of the tab. Side mounting of the flosser 40A permits the option of configuring a device such as a tongue cleaner 40E as shown at the end of handle 40. Side mounting of devices such as toothpick 40C avoids any possible loss of mechanical strength in handle 40 due to handle openings. Locating the tab of key-shaped toothpick 40C in the flosser opening as shown avoids need for a side panel part and saves space.

FIG. 22 is a cut-away front view of a handle portion 42 removably attached at a side edge thereof to a side panel 42B via a pair of snap-off fastenings 42C. Side panel 42B contains a flosser 42C along with one or more hygienic devices: in this embodiment a curved toothpick 42D with a grip tab and interdental brush 42E with a grip tab, each removably attached by snap-off fastening at two opposite side edges as shown. Side mounting of the flosser 42C in a side panel 42B permits the option of configuring a device such as a tongue cleaner 42F as shown at the end of handle 42. Mounting devices externally, e.g. in an external panel 42D, instead of in handle openings benefits the mechanical strength of utensil handle portion 42. Edge-mounted combinations/panels such as in FIGS. 21 and 22 have potential for marketing as stand-alone products.

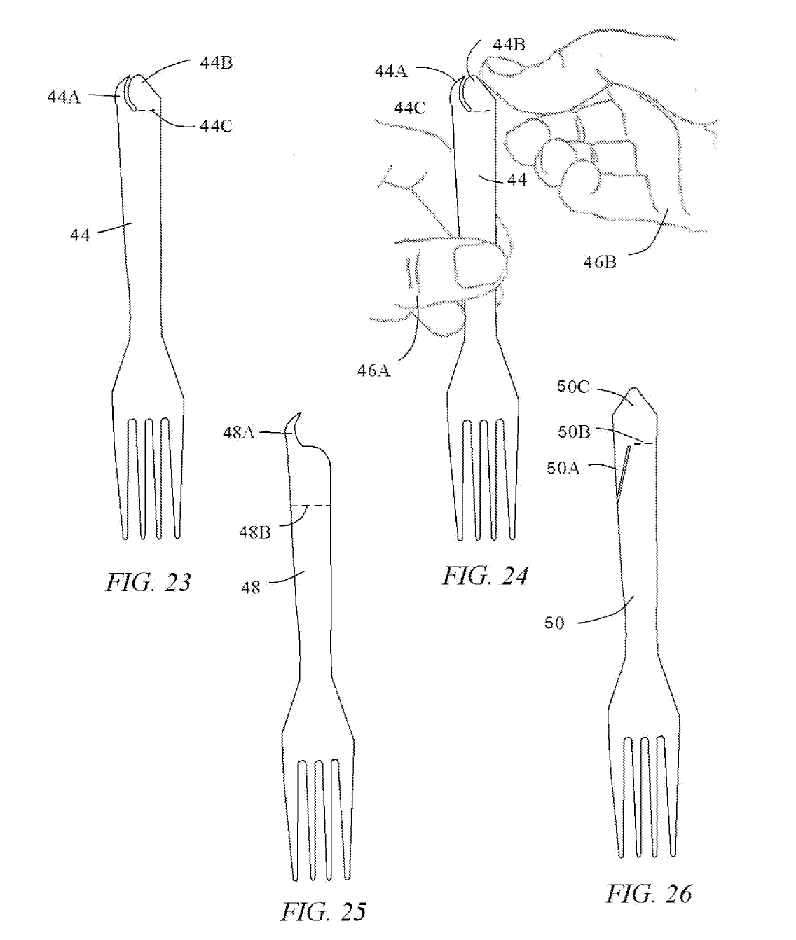

FIG. 23 depicts a fork 44 configured with an attached curved toothpick 44A, protected on one side by an adjacent guard tab 44B that is made user-displaceable at score line 44C so as to expose toothpick 44A for use. Depending on design selection of handle material and configuration of score line 44C, (a) in a bend-away embodiment, tab 44B can be bent back and held by a user to expose the toothpick for usage, but remains attached as a guard for future usage of the fork 44, whereas (b) in a snap-off embodiment, snap-off removal of guard tab 44B leaves toothpick 44A permanently exposed and unguarded.

FIG. 24 shows a user's left hand 46A holding a fork 44 of FIG. 23 while the right hand 46B is shown in process of displacing the guard tab 44B at score line 44C, to expose toothpick 44A ready to use, remaining attached to fork 44 which serves as a handle.

FIG. 25 depicts a fork 48 configured with a snap-off curved toothpick 48A, extending longitudinally from the handle. In a primary version, toothpick 48A is made readily removable by snapping off at score line 48B, providing the toothpick separately with a thumb-finger grip. In a secondary version, score line 48B is made relatively stiff so that toothpick 48A can be considered ready-to-use while remaining attached to fork 48 which serves as a handle. In still another version (FIG. 32), score line 48B is omitted.

FIG. 26 depicts a fork 50 configured with a tapered toothpick 50A that is edge-located and attached to a user-displaceable end tab 50C. A score line 50B, from the base end of toothpick 50A to the handle edge, enables a user to displace tab 50C and thus expose toothpick 50A for use; in a bend-away embodiment, toothpick 50A would remain attached to the handle along with bent back tab 50C, whereas in a snap-off embodiment, toothpick 50A would be removed from the handle along with end tab 50C, which would serve as a thumb/finger grip tab to facilitate use of the toothpick 50A.

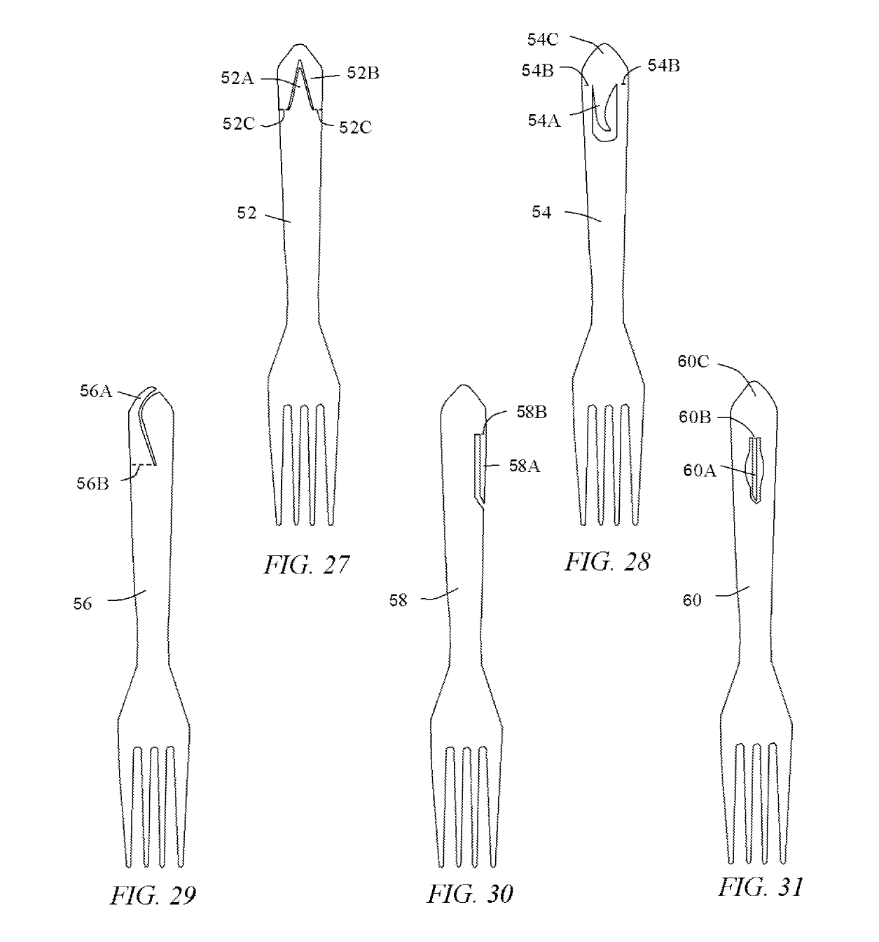

FIG. 27 depicts a fork 52 configured with an attached toothpick 52A that is fully protected by a user-displaceable end tab 52B, which, when user-displaced at score lines 52C, exposes toothpick 52A for use. In a bend-away embodiment, end tab 52B remains attached to the handle of fork 52, facilitating subsequent further use of the fork, whereas in a snap-off embodiment, end tab 52B is snapped off (and typically discarded) to expose the toothpick 52A ready to use, attached to the fork 52 which serves as a hand grip.

FIG. 28 depicts a fork 54 configured with a fully guarded curved toothpick 54A which, in a snap-off embodiment, when snapped off by user displacement at score lines 34B, includes a thumb-finger grip tab 54C. In a bend-away embodiment, when tab 34C is bent back by user displacement at score lines 54B, toothpick 54A becomes exposed, ready for use.

FIG. 29 depicts a fork 56 configured with a partially-guarded curved toothpick 56A which, in a snap-off embodiment, when snapped off at score line 56B, includes a triangular portion that can serve as a thumb-finger grip tab.

FIG. 30 depicts a fork 58 configured with a partially-guarded straight toothpick 58A which, in a snap-off embodiment, snaps off at score line 58B for use as a separate item.

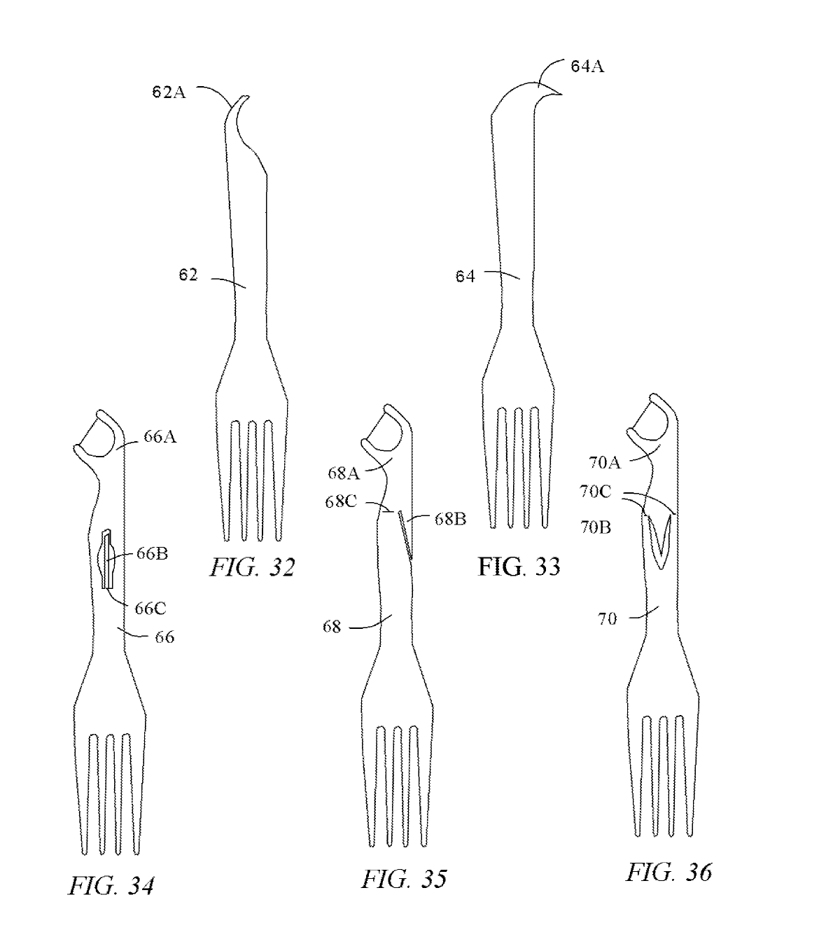

FIG. 31 depicts a fork 60 with a fully guarded straight toothpick 60A which, in a snap-off embodiment, snaps off at score line 60B for use as a separate item, leaving the handle end 60C in place with its original outline shape intact.

FIG. 32 depicts a fork 62 with an unguarded attached curved toothpick 62A, oriented longitudinally, ready to use.

FIG. 33 depicts a fork 64 with an unguarded attached curved toothpick 64A, oriented laterally, ready to use.

FIG. 34 depicts a fork 66 in combination with an attached flosser 66A, ready to use, and an initially attached straight toothpick 66B that snaps off at score line 66C for removal and separate usage. The floss in flosser 66A can be secured in place at the ends of the flosser opening by molding into the plastic material at manufacture or by forcing the floss into narrow V-shaped grooves.

FIG. 35 depicts a fork 68 configured with an edge-located semi-guarded tapered toothpick 68B and a flosser 68A with a score line 68 located to enable a user to expose toothpick 68B for use by dislocating toothpick 68B and a flosser 68A as a combo. Score line 68C is made sufficiently stiff to enable immediate use of flosser 68A with the combo attached in line with the fork 68 as shown, the fork serving as a handle. In a snap-off embodiment, the combined toothpick 68B and flosser 68 can be snapped off from fork 68 at score line 68C, providing the combo of both dental cleaning devices ready to use as a separate unit. In a bend-away embodiment, the user can expose the toothpick 68B for use at any time by bending back the combo at score line 68C.

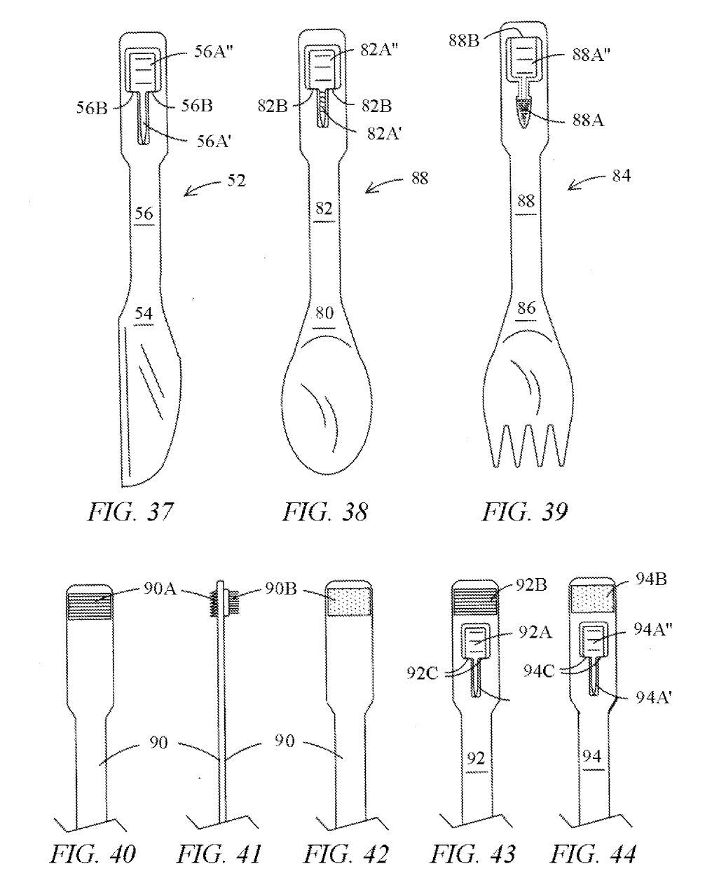

FIG. 36 depicts a toothpick 70B and a flosser 70A in a combo configuration similar to that in FIG. 37 except that toothpick 70B, being centered in the handle, is initially fully guarded by surrounding handle material and is flanked by a pair of score lines 70C for user-displacement; otherwise the capabilities and method of use are as described in connection with FIG. 36.

In a configuration similar to that in FIG. 36, the toothpick and its surrounding guard region opening could be inverted (i.e. rotated 180 degrees) to appear as in FIG. 27. Then, in a snap-off embodiment, the flosser would snap off for separate use, exposing the toothpick ready for use (like 52A in FIG. 27), still attached to the fork. In a bend-away embodiment, the flosser would fold back to expose toothpick for use.

FIG. 37 is a front view of an embodiment 72 of the invention wherein the utensil portion is a cutlery knife 74; its handle 76 is configured in its end region with a fully guarded toothpick 76A′ configured with an enlarged base tab 76A″ that serves as a thumb-finger grip. In a snap-off embodiment, toothpick 76A′ and its attached tab 76A″ can be snapped off at score lines 76B and removed for separate use.

FIG. 38 is a front view of an embodiment 78 of the invention wherein the utensil portion is a spoon 80; its attached handle 82 is configured with an interdental pick 82A′ having an enlarged base tab 82A″ that initially forms the end of handle 82 as shown. In a snap-off embodiment, toothpick 82A′ and attached tab 82A″ can be snapped off at a pair of score lines 82B and removed for separate use. In a bend-away embodiment, toothpick 82A′ and attached tab 82A″ can be deployed by the user bending tab 82A″ back 180 degrees at the pair of score lines 82B, thus exposing interdental pick 82A′ ready for use.

FIG. 39 is a front view of an embodiment 84 of the invention wherein the utensil portion is a spork 86, i.e. spoon/fork, with attached handle 88 configured in its end region with a fully guarded interdental brush 88A′ with an attached enlarged base tab 88A″ that serves as a thumb-finger tab. In a snap-off embodiment, brush 88A′ and attached tab 88A″ can be snapped-off at score line 88B, located along the top edge of base tab 88A″, and removed for separate use. In a bend-away embodiment, interdental brush 88A′ and its attached tab 88A″ can be bent away at score line 88B.

FIG. 40 is a cut-away front view of an eating utensil handle portion 90 including a tongue cleaner 90A located in the end region. Tongue cleaner 90A can be implemented as a row of ridges that can be molded integrally with handle portion 90. Alternatively, tongue cleaner 90A can be implemented as at least one scraping edge, intended to scrape the tongue to remove debris while not causing injury to tongue. As a further option, the region of handle portion 90 that contains the tongue cleaner 90A could be made with permanent bends or made flexible so as to make accessing the tongue easier; the tongue cleaner could be configured with at least one opening that allows debris from the scraping action to pass thru, preferably to a designated collection area.

FIG. 41 is a cut-away side view of utensil handle 90 as in FIG. 40 showing a side view of tongue cleaner 90A, also showing a side view of a bristle brush 90B in the end region on the opposite rear side. The side view of tongue cleaner 90A shows a sawtooth profile shape of the ridges, with the ridge-tips being formed with designated sharpness, appropriate to tongue cleaning. Brush 90B is typically fabricated as a separate item, with bristles of appropriate length and stiffness, and affixed to the end region of handle 90.

FIG. 42 is a cut-away rear view of the utensil handle 90 and brush 90B of FIG. 41. Optionally brush 90B could be implemented as any type of brush that can be used orally, e.g. bristle-type oral brush, interdental-type oral brush, pad/fabricated-type of brush and combinations thereof. The oral brush 90B can be directly molded into the eating utensil handle 90 and/or procured separately and affixed to the handle. The portion of the utensil handle 90 that contains the oral brush could be made with one or more permanent bends or made flexible so as to make accessing teeth/tongue easier; and bristle-type oral brushes could vary in such areas as, but not limited to, count, arrangement, stiffness, color, width, length, material, attachment method to base and combinations thereof.

FIG. 43 is a cut-away front view of an eating utensil handle 92 including a fully guarded snap-off straight toothpick 92A′ with a base tab 92A″ and a tongue cleaner 92B located near the end of handle 92 as in FIG. 40. Toothpick 92A′, along with its base tab 92A″, snaps off at a pair of score lines 92C as shown, to be removed for separate use.

FIG. 44 is a cut-away front view of the eating utensil handle 94 including a fully guarded snap-off straight toothpick 94A′ attached to base tab 94A″, as in FIG. 43, and a brush 94B located near the end of handle 94 as shown and described in connection with FIGS. 41 and 42.

FIG. 44 is a cut-away front view of the eating utensil handle 94 including a fully guarded snap-off straight toothpick 94A′ attached to base tab 94A″, as in FIG. 43, and a brush 94B located near the end of handle 94 as shown and described in connection with FIGS. 41 and 42.

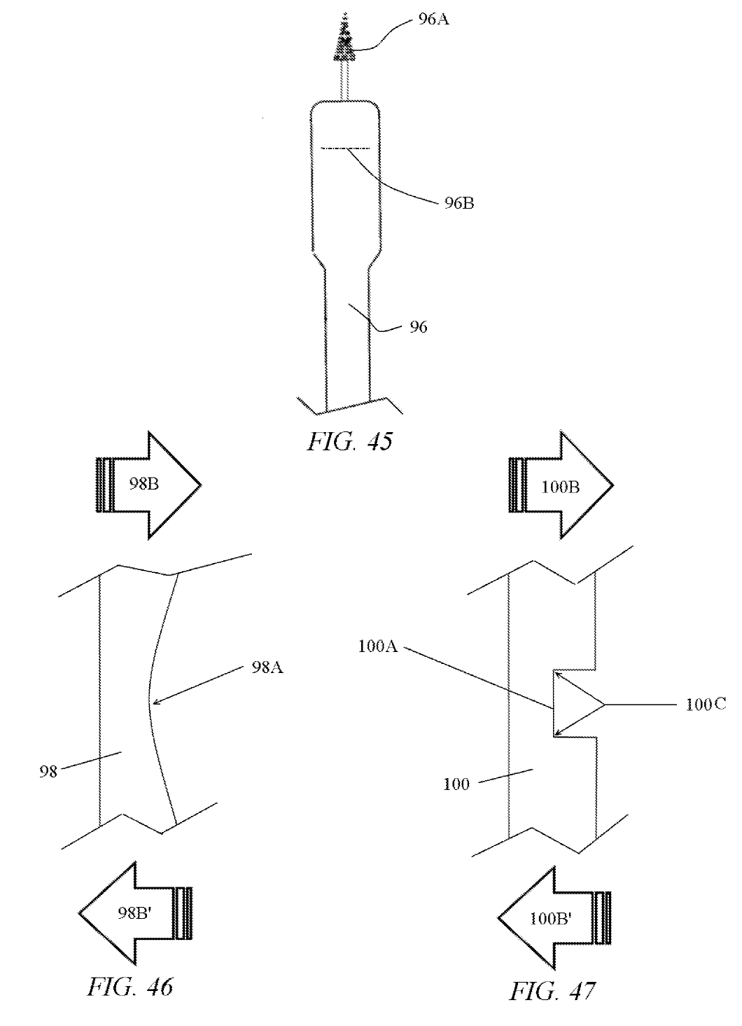

FIG. 45 depicts a cut-away front view of the eating utensil handle 96 with an unguarded attached interdental brush 96A, oriented longitudinally, interdental brush optionally removable at score-line 96B ready to use. In an alternative embodiment score-line 96B could be omitted.

FIGS. 46 and 47 depict side-profile cutaway sections for two invention embodiment types 98/100, each embodiment type 98/100 configured with a different score-line 98A/100A type, said score-lines as could be similar to any applicable score-line as depicted in the current application. When embodiments types 98/100 are fabricated from a brittle material such as polystyrene plastic and a bend-moment is created about score-line 98A/100A, in either direction 98B/100B or 98B′/100B′, at some point complete fracturing (part separation) is likely to occur; and when embodiment types 98/100 are fabricated from a given class-A pliable material type and a bend-moment is created about score-line 98A/100A, in either direction 98B/100B or 98B′/100B′, complete fracturing DOES NOT occur (parts are not separated and respective score-lines act similar to a living-hinge) at said respective score-lines; however when embodiment types 98/100 are fabricated from a given class-B pliable material type, including polypropylene plastic, a unique phenomenon happens. As related to class-B material, in FIG. 46 when bending occurs in either direction 98B/98B′ fracturing DOES NOT occur, due to the lack of any stress concentration points/lines; however in FIG. 47 when bending occurs (slowly) in direction 100B through an angle nearing 90-degrees the material about score-line 100A yields without (completely) fracturing, as a result allowing bending to occur in both directions 100B/100B′ without (complete) fracturing occurring; but if initial bending occurs (quickly) in direction 100B, away from stress concentration points 100C, through an angle nearing 90-degrees (near complete, if not complete) fracturing occurs. The advantage, as shown in FIG. 47, using said class-B material and as related to the invention is, this option allows for invention parts to be removable and/or bent away (meant for use while still attached to the invention), be it oral-hygienic device protective material and/or the oral-hygienic device(s).

Preferable fabrication materials for invention embodiments, and more specifically embodiments containing toothpick related oral-hygienic implements, include pliable (resilient) materials as opposed to less desired rigid (shatter capable) materials, to minimize the likelihood of said oral-hygienic implement breaking during use.

In the present disclosure, wherever a plain toothpick is shown and/or described as the oral cleaning device, it is to be understood that the invention can be practiced incorporating, as an alternative, an interdental pick, an interdental brush; as a another alternative and more specifically any of the oral cleaning devices could be an additional part that is mold-incorporated into related utensil and/or a piece intended for mechanical attachment to related utensil. In an embodiment where the interdental brush is configured into the related utensil, invention being a single molded part, made from one material, said interdental brush parts, including shaft and bristles, could be made from same said material; and in another embodiment where the interdental brush is configured into the related utensil, invention being a single molded part, made from more than one material (i.e. such as a blended plastic mold), said interdental brush parts, including shaft and bristles, could be made from a different material then said related utensil.

In the present disclosure, wherever an interdental brush is shown and/or described as the oral cleaning device, it is to be understood that the invention can be practiced incorporating, as an alternative, an interdental pick, a pick-brush, straight toothpick, curved toothpick, etc.; furthermore and more generally the invention related oral cleaning device can be configured into the related utensil, said invention being a single molded piece, made from a single material; in other embodiments where said oral cleaning device is configured into the related utensil, invention being a single molded part, made from more than one material (i.e. such as a blended plastic mold), said oral cleaning device, could be made from a different material then said related utensil.

While the invention is directed primarily to an unfulfilled need and expected demand in conjunction with disposable plastic eating utensils which are likely to be popular at picnics and other social or public eating events where regular dental cleaning facilities are unavailable, the invention could be practiced in conjunction with more permanent type eating utensils intended for more general use. The material in the eating utensil can be metal or any material that can provide the desired break-away or bend-back embodiment. As an alternative to the generally one-piece construction shown for the eating utensil, it could be made from a plurality of parts joined by fastenings such as welding or adhesives.

Standard fork, spoon or knife designs could include, but are not limited to, such features as ribbed-supports and similar structural/cosmetic elements.

Score lines, which provide removable initial attachment or bendable initial straightness, can be configured for particular type, location, shape and depth, i.e. thickness at the thinnest point. In the design of snap-of embodiments, the material is selected to be relatively brittle and the score line depth is made to enable a user to break the material at the score line. Generally the depth of the score line is chosen to make snap-off easy and convenient, however in special embodiments that require initial stiffness, the score line is made shallower, requiring greater force for snap-off separation. In the design of bend-away embodiments, a more resilient material is selected that can be bent back 180 degrees without breaking off at the score line.

Optional locations of score lines provide many potentially beneficial configurations/embodiments, e.g.:
(a) for user displacement, i.e. snap-off or bend-away, of a device by itself, the score line is simply extended across an edge, typically the base, of the device as shown in FIGS. 29-31, 37-39, 43 & 44.
(b) similarly, an end portion area that forms a protective tab can be made to be displaceable at a score line located across its base as shown in FIGS. 23 & 24;
(c) for a device with one side edge forming part of the handle side edge, a score line extending from a side edge of the device to a corresponding side edge of the handle allows the device to remain permanently attached to the utensil handle or to the end portion (depending on device orientation) when the end portion is snapped-off or bent-away from the utensil handle, thus providing an attached thumb-finger grip tab to facilitate use of the device, as shown in FIGS. 26 & 27;
(d) similarly, for a device located within the handle outline, a pair of score lines extending from side edges of the device base to corresponding opposite side edges of the handle allows the same capability as in (c), as shown in FIGS. 27, 28 & 38; and
(e) a score line can be simply extend fully across the handle at a selected location, enabling the handle to be snapped off into two pieces (or bent-away) at the score line, typically leaving an area of handle material permanently attached to the device to serve as a thumb/finger grip tab, as shown in FIG. 25.

As alternatives to the dental cleaning device being attached to the eating utensil in a permanent or break-away manner with score lines as shown, the invention could be practiced with such attachment made by other fasteners such as temporary glue, magnets, snap-fits, Velcro or the like. It could be arranged for break-away parts to be re-attached.

In embodiments where the dental cleaning device is a toothpick, extreme sharpness at the working end of the toothpick should be avoided as hazardous; instead the point should be made slightly rounded, sufficient to avoid injury, while still shaped optimally to provide effective cleaning capability.

The dental cleaning device, shown as a toothpick or flosser, could also include items such as a tooth brush, pad or fabric type of brush or tongue cleaner integrated into the eating utensil by attachment means such as mold-integration, adhesive or welding, or alternatively bundled in an eating-kit package including one or more eating utensils and/or related items such as a napkin.

As an alternative to floss where a flosser is shown, a rigid, semi-rigid or flexible thin fin or blade could be provided to clean between and around the teeth.

For embodiments such as those shown in FIGS. 25, 32 and 33 where toothpick extends unguarded, a lid or cap of some kind could be included for use as a cover or sheath.

The dental cleaning device could further provide an appropriately designed rough or raised surface, located on its surface or on that of the eating utensil, that could aid in the removal of debris located on the inner walls of the teeth. The debris removal would occur on the insertion and removal of the dental cleaning device.

Supplemental items such as dental floss, tissue paper or mouth wash could be provided either separately, stored within or attached to the eating utensil body in some manner, optionally bundle-wrapped and/or hygienic eating utensils could be individually wrapped.

While the invention has been shown practiced in the form of a fork, spoon, knife and spork, it is to be understood that the invention can be practiced in conjunction with other eating utensils including but not limited to chopsticks, tongs, any other commonly utilized eating utensils and combinations thereof.

It is to be understood that the invention could be configured with permanent/flex-ready bend and/or bends in the eating utensil handle that could make deployment of any dental hygienic devices, permanently/integrally formed in said handle and intended for use while still attached to said handle, more convenient/optimal to access a users oral features such as teeth and tongue.

As an alternative to incorporating the dental cleaning device within or directly attached to the eating utensil, one or more cleaning devices and one or more eating utensil could be included separately side-by-side in sheet of plastic made and arranged to enable break-away removal for use.

Following are numbered aspects of the disclosure that should not be taken as limiting the attached claims:

1. A combination eating utensil and oral hygienic facility, comprising:
a utensil portion of a type selected from a group consisting of forks, spoons, knives and combinations thereof;
a handle portion extending from said eating utensil portion to an end region of the handle portion; and
an oral hygienic device of a type selected from a group consisting of flossers, toothpicks, tongue cleaners and brushes, made in conjunction with and initially attached to said handle portion.

2. A combination eating utensil and oral hygienic facility as defined in aspect 1 wherein said oral hygienic device is a flosser comprising; whereas
said flosser is configured with two ends defining a flosser opening formed in conjunction with said handle portion; and
a length of dental floss attached at each of the two ends of said flosser, extending across the flosser opening.

3. The combination eating utensil and oral hygienic facility as defined in aspect 2 wherein said length of dental floss is oriented in a substantially longitudinal direction relative to said handle portion, made functionally taut and fastened permanently at each of the two ends of said flosser.

4. The combination eating utensil and oral hygienic facility as defined in aspect 2 further comprising:
a hygienic device, selected from a group including a toothpick, an interdental pick, and an interdental brush, initially located and protected within an opening surrounded by material of said handle portion and initially attached removably to said handle portion; and
at least one snap-off score line configured in said handle portion, made and arranged to initially hold said hygienic device in place and, upon snap-off by a user, to separate and expose said hygienic device for deployment.

5. The combination eating utensil and oral hygienic facility as defined in aspect 2 further comprising:

a toothpick formed by a slot configured in said handle portion extending along a first side edge of said toothpick and to an opening thusly formed in a first side edge of said handle portion, a second and opposite side edge of said toothpick forming a portion of the first side edge of said handle portion, said toothpick being initially attached to said handle portion at a baseline of said toothpick; and
a snap-off score line, configured on said handle portion collinear with the baseline of said toothpick, such that upon snap-off at said score line said toothpick becomes exposed ready for use as a dental cleaning device.

6. The combination eating utensil and oral hygienic facility as defined in aspect 4 wherein:
said hygienic device is a toothpick oriented longitudinally in said handle portion.

7. The combination eating utensil and oral hygienic facility as defined in aspect 4 wherein:
said hygienic device is a curved toothpick oriented longitudinally in said handle portion.

8. The combination eating utensil and oral hygienic facility as defined in aspect 4 wherein:
said hygienic device is an interdental pick, oriented longitudinally in said handle portion, made sufficiently thin and abrasive to enable cleaning and debris removal between adjacent teeth.

9. The combination eating utensil and oral hygienic facility as defined in aspect 4 wherein:
said hygienic device is an interdental brush, oriented longitudinally in said handle portion, made sufficiently thin and abrasive to enable cleaning and debris removal between adjacent teeth.

10. The combination eating utensil and oral hygienic facility as defined in aspect 4 wherein:
said hygienic device is a straight toothpick oriented longitudinally in said handle portion and having a first end free but protected by surrounding material and a second end initially attached to said handle portion at a baseline of the toothpick, said handle portion being configured with a score line extending across the baseline, whereby the toothpick can be removed in a snap-off manner at the score line, ready for use.

11. The combination eating utensil and oral hygienic facility as defined in aspect 2 wherein said dental flosser is located in the end region of said handle portion, the end region being demarked by a bend line, configured laterally across said handle portion, made and arranged to allow flexible bending at the bend line, thus enabling a user to deploy said dental flosser at a desired angle relative to said handle portion.

12. The combination eating utensil and oral hygienic facility as defined in aspect 2 wherein said dental flosser is located in the end region of said handle portion, the end region being demarked by a lateral bend line at which a bend placed in said handle is made to hold the end region including said dental flosser for use at a predetermined angle of inclination.

13. The combination eating utensil and oral hygienic facility as defined in aspect 2 further comprising:
said flosser being located in the end region;
a hygienic device formed within said handle portion as a permanent part thereof, oriented longitudinally and extending from a lateral baseline toward said flosser;
a pair of bend lines extending collinearly from opposite ends of the baseline to corresponding side edges of said handle portion, each bend line defining a region of said handle portion configured with resilient flexible material capable of repeated bending up to 180 degrees, whereby a user is enabled to fold back the end portion 180 degrees along with said flosser thus exposing said hygienic device extending from the thusly shortened handle portion, ready for use.

14. The combination eating utensil and oral hygienic facility as defined in aspect 13 wherein said hygienic device is an interdental brush that is made sufficiently thin and abrasive to enable cleaning and debris removal between adjacent teeth.

15. The combination eating utensil and oral hygienic facility as defined in aspect 13 wherein said hygienic device is a toothpick.

16. The combination eating utensil and oral hygienic facility as defined in aspect 13 wherein said hygienic device is an interdental pick.

17. The combination eating utensil and oral hygienic facility as defined in aspect 2 further comprising:
a tongue cleaner located endmost in the end region of said handle portion; and
said flosser being located in said handle portion, next-to-endmost, adjacent to said tongue cleaner.

18. The combination eating utensil and oral hygienic facility as defined in aspect 2 further comprising:
a tongue cleaner located endmost in the end region on a first side of said handle port an oral brush located endmost in the end region of a second and opposite side of said handle portion; and
said flosser being located next-to-endmost region of said handle portion.

19. The combination eating utensil and oral hygienic facility as defined in aspect 2 further comprising:
an oral brush located endmost in the end region of said handle portion; and
said flosser being located in said handle portion, next-to-endmost, adjacent to said oral brush.

20. The combination eating utensil and oral hygienic facility as defined in aspect 2 wherein
said combination eating utensil and dental flosser is molded from plastic; and
said dental flosser is permanently located endmost in the end region of said handle portion; and said combination eating utensil and dental flosser is further configured with a combination device assembly, formed within a longitudinal opening in said handle portion, comprising:
a thumb-finger grip tab of generally rectangular shape having first, second, third and fourth side edges numbered consecutively, the first side edge and the third and opposite side edge being removably attached in a snap-off manner to corresponding opposite side edges of the longitudinal opening;
a first hygienic device affixed at a baseline thereof to a second first side edge of said grip tab;
a second hygienic device affixed at a baseline thereof to a fourth and opposite side edge of said grip tab; and
said first and second hygienic devices being selected from a group including a straight toothpick, a curved toothpick, an interdental pick and an interdental brush.

21. The combination eating utensil and oral hygienic facility as defined in aspect 2 wherein
said dental flosser is configured with two arms straddling the flosser opening and each arm extending to a respective one of the two ends of said dental flosser;
one of the arms is widened to form a thumb-finger grip tab; and
said dental flosser is initially located adjacent to said handle portion with the two ends interfacing a side edge of said handle portion, removably fastened in place by at least one snap-off fastening joining a portion of one of the ends to the side edge of said handle portion.

22. The combination eating utensil and oral hygienic facility as defined in aspect 2 further comprising:
said dental flosser being configured with a narrow arm forming a first edge of the flosser opening and a wide arm forming a second and opposite edge of the flosser opening, each arm extending to a respective one of the two ends of said dental flosser;
said dental flosser being initially located adjacent to said handle portion with the two ends interfacing an edge of said handle portion, said flosser being removably fastened in place by at least one snap-off fastening joining a portion of an edge of the flosser to a corresponding portion of an edge of said handle portion;
said dental flosser being configured with a slot opening extending perpendicularly from a side edge of the flosser opening on the wide arm, and initially further comprising a key-shaped hygienic device selected from a group including a toothpick, an interdental pick and an interdental brush;
the key-shaped hygienic device having a generally rectangular enlarged base end made and arranged to serve as a thumb-finger grip tab portion, said device being located with the tab portion contained within the flosser opening and with a narrow working part of the device extending from the tab portion into the slot opening; and
the key-shaped hygienic device being removably fastened by snap-off attachment to at least one edge region of the flosser opening.

23. The combination eating utensil and oral hygienic facility as defined in aspect 1, further comprising an integrally formed side panel removably attached to an edge of said handle portion, the side panel configured with at least one opening containing a removably attached hygienic device selected from a group including a flosser, toothpick, an interdental pick and an interdental brush.

24. The combination eating utensil and oral hygienic facility as defined in aspect 1 comprising, in further combination, at least one hygienic device selected from a group that includes a straight toothpick, a curved toothpick, a bristle brush, an abrasive scrub pad, an interdental pick, an interdental brush and a tongue cleaner.

25. The combination eating utensil and oral hygienic facility as defined in aspect 24 wherein said hygienic device is configured in a key shape having a relatively narrow working end portion and an opposite base end portion made wider and sufficiently large enough to serve as a thumb-finger grip tab to facilitate deployment.

26. The combination eating utensil and oral hygienic facility as defined in aspect 1 wherein said oral cleaning device comprises a toothpick, attached to the handle portion of said eating utensil, extending from the end region, exposed ready for use.

27. The combination eating utensil and oral hygienic facility as defined in aspect 1 wherein said oral cleaning device comprises a toothpick.

28. The combination eating utensil and oral hygienic facility as defined in aspect 1 wherein said oral cleaning device comprises:
a toothpick having a side edge initially forming a portion of a side edge of said handle portion, said toothpick having a base end initially attached to said handle portion along a portion of a baseline traversing said handle portion; and
a score line, located along a selected portion of the baseline, made and arranged to enable a user to displace and expose said toothpick ready for use.

29. The combination eating utensil and oral hygienic facility as defined in aspect 1 further comprising:
said oral cleaning device being formed in the end region of said handle portion, in an opening therein surrounded by a protective end area of handle material;
a base end of said oral cleaning device being permanently attached to said handle portion; and
a pair of score lines, configured in said handle portion, extending from respective opposite side edges of the base end of said oral cleaning device to corresponding side edges of said handle
portion, said score lines being made and arranged to enable a user to displace the protective end area and thus expose said oral cleaning device, remaining attached to said handle portion, ready for use.

30. The combination eating utensil and oral hygienic facility as defined in aspect 1 further comprising:
said oral cleaning device being formed in an opening in said handle portion surrounded by a protective area of handle material, said oral cleaning device having a base end oriented toward and permanently attached to the end region; and
a pair of score lines, configured in the end region, extending from respective opposite side edges of the base end of said oral cleaning device to corresponding side edges of said handle portion, said score lines being made and arranged to enable a user to displace the end region and thus expose said oral cleaning device, remaining attached to the displaced end portion, ready for use.

31. The combination eating utensil and oral hygienic facility as defined in aspect 1 further comprising:
a curved toothpick, constituting said oral cleaning device, configured in the end region with a curved edge of said curved toothpick forming a portion of a curved end outline of said handle portion;
a base end of said curved toothpick, directed toward said utensil portion;
a snap-off score line extending across the base end; and
said curved toothpick being thusly protected on one side by an adjacent tab of handle material permanently attached to said handle portion, such that, upon snap-off at said score line, said curved toothpick becomes detached and exposed, ready for use as a separate item.

32. The combination eating utensil and oral hygienic facility as defined in aspect 1 further comprising:
a toothpick, constituting said oral cleaning device, having a side edge thereof initially forming a portion of a side edge of said handle portion;
said toothpick being oriented with a base end thereof directed toward the end region; and
a score line, configured across the base end of said toothpick, made and arranged to enable user-displacement of said toothpick to expose said toothpick ready for use.

33. The combination eating utensil and oral hygienic facility as defined in aspect 1 further comprising:
said oral cleaning device being initially formed in an opening in said handle portion, surrounded and protected by handle material;
a base end of said oral cleaning device, initially attached to said handle portion; and
a score line, configured across the base end of said oral cleaning device, made and arranged to enable user-displacement and exposure of said oral cleaning device ready for use.

34. The combination eating utensil and oral hygienic facility as defined in aspect 1 wherein said oral cleaning device is integrally formed from and permanently attached to said handle portion, extending generally longitudinally from the end region ready for use.

35. The combination eating utensil and oral hygienic facility as defined in aspect 1 wherein said oral cleaning device is integrally formed from and permanently attached to said handle portion, extending generally laterally from the end region ready for use.

36. The combination eating utensil and oral cleaning facility as defined in aspect 33, further comprising a dental flosser extending from the end region, ready for use.

37. The combination eating utensil and oral cleaning facility as defined in aspect 28, further comprising a dental flosser extending from the end region, ready for use.

38. The combination eating utensil and oral cleaning facility as defined in aspect 30, further comprising a dental flosser extending from the end region, ready for use.

39. The combination eating utensil and oral hygienic facility as defined in aspect 1, wherein said eating utensil is a cutlery knife.

40. The combination eating utensil and oral hygienic facility as defined in aspect 1 wherein said eating utensil is a spoon.

41. The combination eating utensil and oral hygienic facility as defined in aspect 1, wherein said eating utensil is a spork.

42. The combination eating utensil and oral hygienic facility as defined in aspect 1, wherein said oral cleaning device is a tongue cleaner integrally formed in the end region on a first side of said handle portion.

43. The combination eating utensil and oral hygienic facility as defined in aspect 42, further comprising a bristle brush located in the end region on a second side of the handle, opposite the first side thereof.

44. The combination eating utensil and oral cleaning facility as defined in aspect 1, wherein said oral cleaning device is an oral brush, located in the end region of said handle portion, selected from a group including a bristle brush and an abrasive scrubbing pad brush.

45. The combination eating utensil and oral cleaning facility as defined in aspect 42 further comprising an additional oral cleaning device located in said handle portion between the tongue cleaner and said utensil portion, displaceably attached to adjacent handle material in at least one location configured with a score line enabling a user to displace and expose said additional oral cleaning device for use.

46. The combination eating utensil and oral cleaning facility as defined in aspect 44 further comprising an additional oral cleaning device located in said handle portion between the bristle brush and said utensil portion, displaceably attached to adjacent handle material in at least one location configured with a score line enabling a user to displace and expose said additional oral cleaning device for use.

The invention may be embodied and practiced in other specific forms without departing from the spirit and essential characteristics thereof. The present embodiments are therefore to be considered in all respects as illustrative and not restrictive, the scope of the invention being indicated by the appended claims rather than by the foregoing description; and all variations, substitutions and changes which come within the meaning and range of equivalency of the claims are therefore intended to be embraced therein.

What is claimed is:

1. A combination eating utensil and oral cleaning facility, comprising:
an eating utensil portion of a type selected from a group consisting of forks, spoons, knives and combinations thereof;
a handle portion extending from said eating utensil portion to an end region of the handle portion; and
an oral cleaning device of a type selected from a group consisting of a toothpick, an interdental pick, and interdental brush, a tongue cleaner and an oral brush, made in conjunction with and initially attached to said handle portion, at least a portion of the combination facility being displaceable to allow the oral cleaning device to be used while still attached to the eating utensil portion.

2. The combination eating utensil and oral cleaning facility as defined in claim 1 wherein said oral cleaning device is an interdental brush.

3. The combination eating utensil and oral cleaning facility as defined in claim 2 wherein said handle portion is configured in a manner to enable bend-away displacement of said interdental brush for use without detaching from said handle portion.

4. The combination eating utensil and oral cleaning facility as defined in claim 1 wherein said oral cleaning device comprises:
said toothpick having a side edge initially aligned with a side edge of said handle portion, said toothpick having a base end initially attached to said handle portion along a portion of a baseline traversing said handle portion; and
a score line, located along a selected portion of the baseline, made and arranged to enable a user to displace and expose said toothpick ready for use.

5. The combination eating utensil and oral cleaning facility as defined in claim 2 further comprising:
said interdental brush being located in the end region of said handle portion, in an opening therein surrounded by a protective region of handle material;
a base end of said interdental brush being permanently attached to said handle portion; and
a pair of score lines, configured in said handle portion, extending from respective opposite side edges of the base end of said interdental brush to corresponding side edges of said handle portion, said score lines being made and arranged to enable a user to displace the protective region and thus expose said interdental brush, remaining attached to said handle portion, ready for use.

6. The combination eating utensil and oral cleaning facility as defined in claim 2 further comprising:
said interdental brush being located in an opening in said handle portion surrounded by a protective area of handle material, said interdental brush having a base end oriented toward and permanently attached to the end region; and
a pair of score lines, configured in the end region, extending from respective opposite side edges of the base end of said interdental brush to corresponding side edges of said handle portion, said score lines being made and arranged to enable a user to displace the end region and thus expose said interdental brush, remaining attached to the displaced end portion, ready for use.

7. The combination eating utensil and oral cleaning facility as defined in claim 1 further comprising:
said toothpick, constituting said oral cleaning device, configured in the end region with an edge of said toothpick forming a portion of an end outline of said handle portion;
a base end of said toothpick, directed toward said utensil portion;
a displaceable score line extending across the base end; and
said toothpick being thusly protected on one side by an adjacent tab of handle material permanently attached to said handle portion, such that, upon displacement at said score line, said toothpick becomes exposed, ready for use.

8. The combination eating utensil and oral cleaning facility as defined in claim 1 further comprising:
said toothpick, constituting said oral cleaning device, having a side edge thereof initially aligned with a portion of a side edge of said handle portion;
said toothpick being oriented with a base end thereof directed toward the end region; and
a score line, configured across the base end of said toothpick, made and arranged to enable user-displacement of said toothpick to expose said toothpick ready for use.

9. The combination eating utensil and oral cleaning facility as defined in claim 2 further comprising:
said interdental brush being initially located in an opening in said handle portion, surrounded and protected by handle material;
a base end of said interdental brush, initially attached to said handle portion; and
a score line, configured across the base end of said interdental brush, made and arranged to enable user-displacement and exposure of said interdental brush ready for use.

10. The combination eating utensil and oral cleaning facility as defined in claim 2 wherein said interdental brush is integrally formed from and permanently attached to said handle portion.

11. The combination eating utensil and oral cleaning facility as defined in claim 2 wherein said interdental brush is integrally formed from and permanently attached to said handle portion, extending from the end region ready for use.

12. The combination eating utensil and oral cleaning facility as defined in claim 9, further comprising a dental flosser extending from the end region, ready for use.

13. The combination eating utensil and oral cleaning facility as defined in claim 4, further comprising a dental flosser extending from the end region, ready for use.

14. The combination eating utensil and oral cleaning facility as defined in claim 6, further comprising a dental flosser extending from the end region, ready for use.

15. The combination eating utensil and oral cleaning facility as defined in claim 2 wherein said interdental brush is initially protected by a displaceable guard region of handle material.

16. The combination eating utensil and oral cleaning facility as defined in claim 1, wherein said eating utensil is selected as a spork.

17. The combination eating utensil and oral cleaning facility as defined in claim 2, further comprising a tab positioned to assist in displacing at least a portion of the combination facility to allow the interdental brush to be used while still attached to the eating utensil.

18. An eating and oral-cleaning facility, comprising an eating utensil; and
an oral cleaning device; and
a fixed material portion of the eating utensil; and
a permanent and displacably attached material portion of the eating utensil;
wherein the permanent and displacably attached material portion can be displaced about a bend-line to present the oral cleaning device ready for use.

19. The facility of claim 18, wherein the eating utensil is selected from a group consisting of a spoon, fork, knife, and combinations thereof.

20. The facility of claim 18, wherein said oral cleaning device is incorporated into the permanent and displacably attached material portion of the eating utensil.

21. The facility of claim 18, wherein:
the oral cleaning device is integrated with the fixed material portion; and
the permanent and displacably attached material portion when displaced exposes the oral cleaning device ready for use.

22. The facility of claim 18, wherein the oral cleaning device is an interdental brush.

23. A method comprising:
using an eating utensil of an eating and oral-cleaning facility, the eating and oral cleaning facility also comprising:
an oral cleaning device;
a fixed material portion of the eating utensil; and
a permanent and displaceably attached material portion of the eating utensil;
displacing the permanent and displaceably attached material portion about a bend-line to present the oral cleaning device for use; and
using the oral cleaning device while the oral cleaning device is presented for use.

24. The method of claim 31, wherein the oral cleaning device is an interdental brush.
